(19) United States
(12) Patent Application Publication
(10) Pub. No.: US 2023/0128548 A1
(43) Pub. Date: Apr. 27, 2023

(54) FEDERATED LEARNING DATA SOURCE SELECTION

(71) Applicant: International Business Machines Corporation, Armonk, NY (US)

(72) Inventors: Ruhi Sharma Mittal, Bengaluru (IN); Ramasuri Narayanam, Andhra Pradesh (IN); Lokesh Nagalapatti, Chennai (IN); Sameep Mehta, Bangalore (IN)

(21) Appl. No.: 17/509,507

(22) Filed: Oct. 25, 2021

(51) Int. Cl. G06N 5/02; G06N 5/04

(52) U.S. Cl. CPC G06N 5/022; G06N 5/04

(57) ABSTRACT

One embodiment provides a method, including: receiving, at a central server, data from each of a plurality of data sources, the plurality of data sources being within a plurality of data storage locations, wherein the central server includes a validation dataset having a plurality of annotated datapoints; computing, at the central server, an influential score for each of the plurality of data sources based upon the data provided to the central server from each of the plurality of data sources, wherein an influential score of a data source identifies an influence of the data source in accurately predicting annotations of the validation dataset; selecting, at the central server and based upon the influential score of the plurality of data sources, a subset of the plurality of data sources; and generating, at the central server, the training dataset utilizing the data of the data sources included within the subset.

### BACKGROUND

Machine-learning models are trained using a training dataset that includes annotations or labels identifying a correct classification for the datapoint corresponding to the annotation. A training dataset for a machine-learning model can include hundreds or even thousands of datapoints and corresponding annotations. In order to compile this training dataset, a user may access data sources that contain data that can be used for training the machine-learning model. The data sources may include data sources that reside within a cloud location, a remote network location, a local network location, or the like. However, data sources may not want to share too much information about its data, so it may provide high-level statistics or other information derived from the underlying data instead of the underlying data itself.

### BRIEF SUMMARY

In summary, one aspect of the invention provides a method, including: receiving, at a central server, data from each of a plurality of data sources, the plurality of data sources being within a plurality of data storage locations, wherein the central server includes a validation dataset having a plurality of annotated datapoints and wherein the central server trains a machine-learning model utilizing a training dataset; computing, at the central server, an influential score for each of the plurality of data sources based upon the data provided to the central server from each of the plurality of data sources, wherein an influential score of a data source identifies an influence of the data source in accurately predicting annotations of the validation dataset when the data is used in the machine-learning model; selecting, at the central server and based upon the influential score of the plurality of data sources, a subset of the plurality of data sources; and generating, at the central server, the training dataset utilizing the data of the data sources included within the subset.

Another aspect of the invention provides an apparatus, including: at least one processor; and a computer readable storage medium having computer readable program code embodied therewith and executable by the at least one processor; wherein the computer readable program code is configured to receive, at a central server, data from each of a plurality of data sources, the plurality of data sources being within a plurality of data storage locations, wherein the central server includes a validation dataset having a plurality of annotated datapoints and wherein the central server trains a machine-learning model utilizing a training dataset; wherein the computer readable program code is configured to compute, at the central server, an influential score for each of the plurality of data sources based upon the data provided to the central server from each of the plurality of data sources, wherein an influential score of a data source identifies an influence of the data source in accurately predicting annotations of the validation dataset when the data is used in the machine-learning model; wherein the computer readable program code is configured to select, at the central server and based upon the influential score of the plurality of data sources, a subset of the plurality of data sources; and wherein the computer readable program code is configured to generate, at the central server, the training dataset utilizing the data of the data sources included within the subset.

An additional aspect of the invention provides a computer program product, including: a computer readable storage medium having computer readable program code embodied therewith, the computer readable program code executable by a processor; wherein the computer readable program code is configured to receive, at a central server, data from each of a plurality of data sources, the plurality of data sources being within a plurality of data storage locations, wherein the central server includes a validation dataset having a plurality of annotated datapoints and wherein the central server trains a machine-learning model utilizing a training dataset; wherein the computer readable program code is configured to compute, at the central server, an influential score for each of the plurality of data sources based upon the data provided to the central server from each of the plurality of data sources, wherein an influential score of a data source identifies an influence of the data source in accurately predicting annotations of the validation dataset when the data is used in the machine-learning model; wherein the computer readable program code is configured to select, at the central server and based upon the influential score of the plurality of data sources, a subset of the plurality of data sources; and wherein the computer readable program code is configured to generate, at the central server, the training dataset utilizing the data of the data sources included within the subset.

For a better understanding of exemplary embodiments of the invention, together with other and further features and advantages thereof, reference is made to the following description, taken in conjunction with the accompanying drawings, and the scope of the claimed embodiments of the invention will be pointed out in the appended claims.

### BRIEF DESCRIPTION OF THE SEVERAL VIEWS OF THE DRAWINGS

FIG. 1 depicts a cloud computing environment according to an embodiment of the present invention.

FIG. 2 depicts abstraction model layers according to an embodiment of the present invention.

FIG. 3 illustrates a method of selecting a subset of data sources for federated learning in training a machine-learning model.

FIG. 4 illustrates a bipartite graph generated for selecting a subset of the data sources in view of the validation dataset points.

FIG. 5 illustrates an example overall system architecture for selecting a subset of data sources for federated learning in training a machine-learning model.

FIG. 6 illustrates a computer system.

### DETAILED DESCRIPTION

It will be readily understood that the components of the embodiments of the invention, as generally described and illustrated in the figures herein, may be arranged and designed in a wide variety of different configurations in addition to the described exemplary embodiments. Thus, the following more detailed description of the embodiments of the invention, as represented in the figures, is not intended to limit the scope of the embodiments of the invention, as claimed, but is merely representative of exemplary embodiments of the invention.

Reference throughout this specification to “one embodiment” or “an embodiment” (or the like) means that a particular feature, structure, or characteristic described in connection with the embodiment is included in at least one embodiment of the invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in at least one embodiment. In the following description, numerous specific details are provided to give a thorough understanding of embodiments of the invention. One skilled in the relevant art may well recognize, however, that embodiments of the invention can be practiced without at least one of the specific details thereof, or can be practiced with other methods, components, materials, et cetera. In other instances, well-known structures, materials, or operations are not shown or described in detail to avoid obscuring aspects of the invention.

The illustrated embodiments of the invention will be best understood by reference to the figures. The following description is intended only by way of example and simply illustrates certain selected exemplary embodiments of the invention as claimed herein. It should be noted that the flowchart and block diagrams in the figures illustrate the architecture, functionality, and operation of possible implementations of systems, apparatuses, methods and computer program products according to various embodiments of the invention. In this regard, each block in the flowchart or block diagrams may represent a module, segment, or portion of code, which comprises at least one executable instruction for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

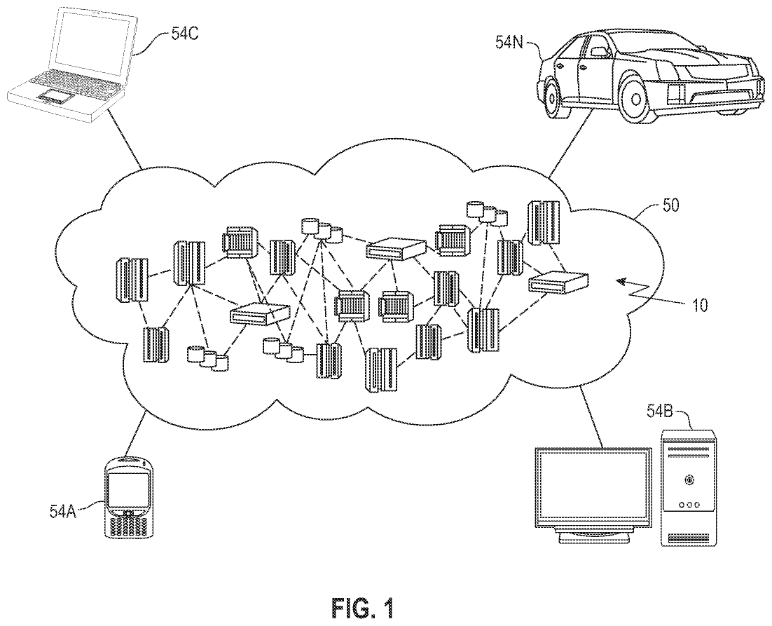

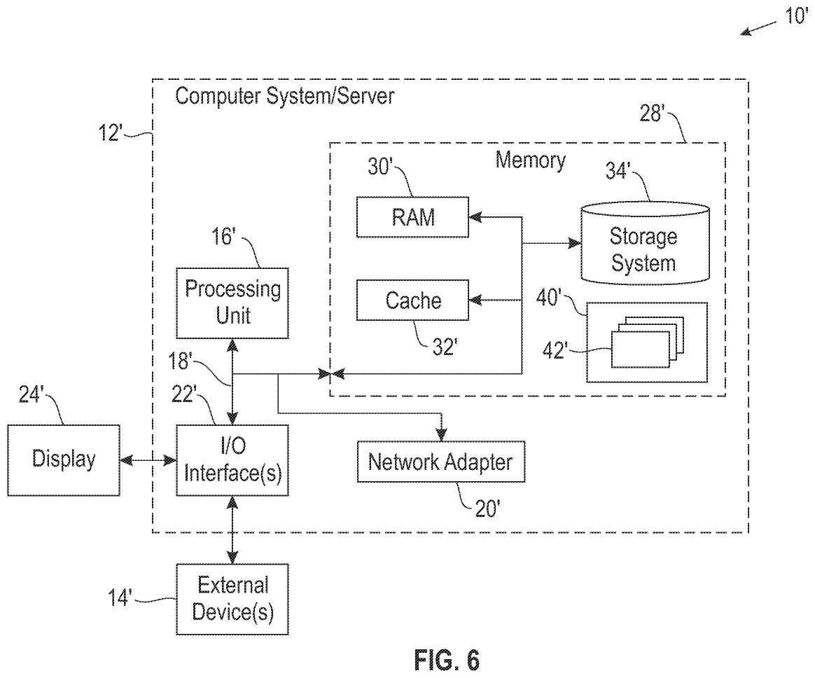

Specific reference will be made here below to FIGS. 1-6. It should be appreciated that the processes, arrangements and products broadly illustrated therein can be carried out on, or in accordance with, essentially any suitable computer system or set of computer systems, which may, by way of an illustrative and non-restrictive example, include a system or server such as that indicated at 12′ in FIG. 6. In accordance with an example embodiment, most if not all of the process steps, components and outputs discussed with respect to FIGS. 1-5 can be performed or utilized by way of a processing unit or units and system memory such as those indicated, respectively, at 16′ and 28′ in FIG. 6, whether on a server computer, a client computer, a node computer in a distributed network, or any combination thereof.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resource but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

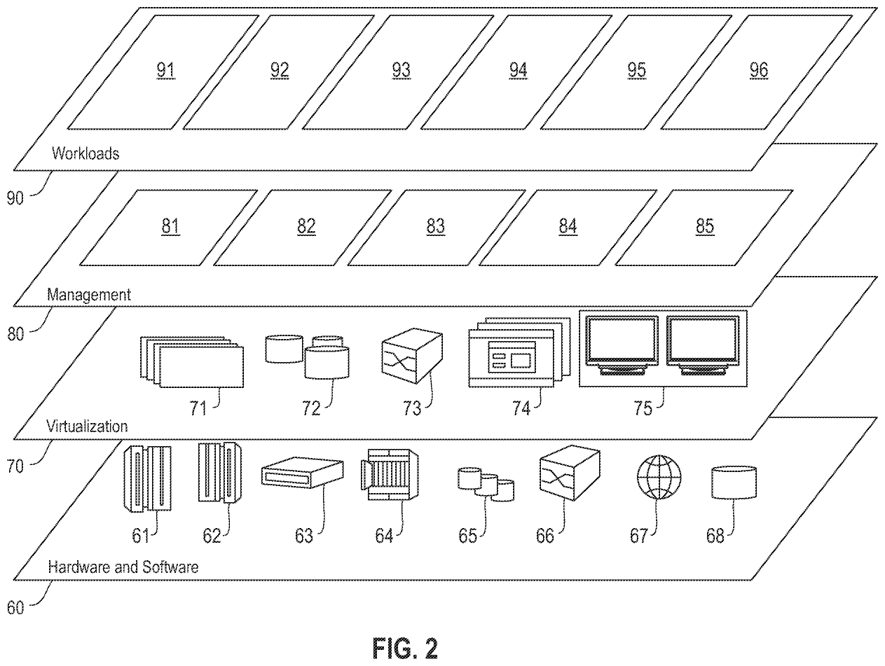

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and machine-learning model training and federated learning 96.

Typically, it is useful to use a large amount of data when creating a training dataset. Additionally, it is useful to use diverse data so that the machine-learning model can be accurately trained. If only a single data source is utilized, it may be difficult to obtain a large amount of data and also to ensure the diversity of the data. Accordingly, many training datasets are compiled using more than one data source. Utilizing multiple data sources allows for obtaining a desired amount of data and also allows for a more diverse training dataset. However, in traditional training applications all of the data must reside in the same location, for example, the same cloud location, the same remote network location, or the same local network location. The traditional training applications do not work across data storage locations which reduces the availability of data for creating the training dataset.

In order to use data that is stored across multiple data storage locations, referred to as hybrid data, using conventional techniques, the data has to be pooled into a single data storage location. However, due to compliance, security, data privacy, network performance, and other constraints, it is difficult, if not impossible, to pool data across the different data storage locations. For example, pooling the data results in a sharing of data between data sources, which is typically undesirable to a data source. Rather, data sources typically only share some form of derived data with the entity attempting to compile the training dataset. However, if the data is pooled, then all data sources would be privy to the underlying data which would result in data sources making the data unavailable for use in generating a training dataset. The hybrid data is, therefore, unavailable for use in generating the training dataset. Rather, the user has to choose a single data source or, at best, pool only a small subset of the data into a single data source, thereby significantly limiting the amount of data available for use in the training dataset. Thus, traditional artificial intelligence models are inadequate for hybrid data analytics where the hybrid data resides in more than one data storage location.

Additionally, if hybrid data could be utilized, there may be hundreds of data sources that could provide the desired data. Utilizing all of the data sources for generating the training dataset results in large amounts of noise in the dataset. Noise in a dataset are those data points that result in inaccurate labeling or annotations within the training dataset. For example, if the training dataset is used to train a model to annotate pictures of animals, training data where pictures of animals are inaccurately labeled with the wrong animal are considered noisy datapoints. An entity wants to minimize the amount of noise within a training dataset, by selecting data from one or more data sources that is the most accurate.

Accordingly, an embodiment provides a system and method for selecting a subset of data sources for federated learning in training a machine-learning model. A central server which is connected to a plurality of data sources receives data from each of the plurality of data sources. The data sources may be within a plurality of data storage locations. For example, one data source may be contained within one cloud storage location and another data source may be contained within a local network storage location. Thus, the data obtained by the central server is hybrid data. The central server has a validation dataset which includes datapoints and correct annotations for the datapoints within the validation dataset. The central server utilizes the data received from the data sources to generate a training dataset which can be used to train a machine-learning model.

However, utilizing all of the data received at the central server from all of the data sources results in a noisy training dataset. Accordingly, the central server selects a subset of the data sources to use data from. To select the subset, the central server computes an influential score for each of the data sources. The influential score is computed based upon the data provided to the central server. The influential score identifies an influence of the data source in accurately predicting annotations of the validation dataset when the data is used in the machine-learning model. In other words, when the data from each data source is integrated into the training dataset which is then used to train the machine-learning model, the machine-learning model can be analyzed against the validation dataset to determine if the model accurately predicts the annotations of the validation dataset. Data from each data source has an influence on the overall accuracy of the model. This influence can be computed through computation of the influential score.

Based upon the computed influential scores, the central server can select a subset of the data sources to use for generating the training dataset. In addition to the computed influential scores, the central server may use user or system provided constraints in selecting the subset of data sources. For example, a user may identify a maximum number of data sources that can be utilized in the subset. As another example, the system may have a requirement for a minimum number of datapoints within the validation dataset that need to be covered by the subset. Covering a datapoint means that data of the data source will cause or assist the model in accurately predicting the annotation corresponding to the datapoint. Once the subset is selected, the central server can generate the training dataset using the data of the data sources in the subset. The training dataset can then be used to train the machine-learning model.

Such a system provides a technical improvement over current systems for generating a training dataset for training a machine-learning model. The described system and method are able to utilize hybrid data for generating a training dataset. In generating the training dataset, the system selects a subset of the data sources that results in the most accurate training dataset. In other words, the system identifies those data sources whose data results in the most accurate predictions by the machine-learning model. Thus, the described system and method provides a technique for generating a training dataset from hybrid data utilizing federated learning while reducing the number of data sources utilized in generating the training dataset. Accordingly, the described system and method is more efficient in generating a training dataset than utilizing a traditional federated learning system and also allows for use of diverse data from multiple data sources across different data storage locations which is not possible using traditional training dataset generation techniques which only allow for data to be used from one data storage location.

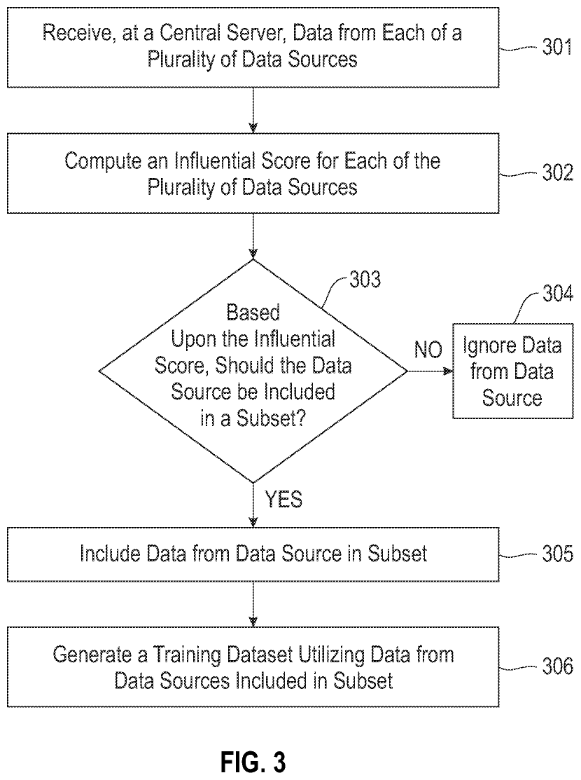

FIG. 3 illustrates a method for selecting a subset of data sources for federated learning in training a machine-learning model. At 301, a central server receives data from each of a plurality of data sources. The central server is an entity that is connected to each of the data sources. The central server may be located in a cloud storage location, remote storage location, local storage location, or the like. The central server generates a training dataset for training a machine-learning model, and after the training dataset is generated, the central server trains the machine-learning model. The central server includes a validation dataset that has a plurality of annotated datapoints. An annotated datapoint is a datapoint or feature that includes a correct classification label. In other words, the annotated datapoint has a label that indicates how the datapoint or feature should be classified by a correctly trained machine-learning model. The validation dataset is a small set of datapoints, for example, a hundred datapoints. This is in contrast to a training dataset which may include thousands or tens of thousands of datapoints.

The central server is connected to many different data sources, where each data source has its own data. The number of data sources may be in the hundreds. The data can be utilized in generating a training dataset for a machine-learning model. However, data sources generally have privacy settings that prevent the data source from sharing the underlying data with outside source, which include other data sources and the central server. Accordingly, the data source does not share the underlying data with the central server but instead shares some derivative of the underlying data with the data source. An example derivative of the underlying data is high-level statistics of the underlying data. Another example derivative of the underlying data is a redacted form of the underlying data. The derivation of the underlying data that is shared is based upon the privacy settings of the data source. Accordingly, different data sources may share different derivations of underlying data with the central server.

The data sources are within a plurality of data storage locations, making the data received at the central server hybrid data. For example, the data sources may be within a combination of cloud storage locations, remote network storage locations, local network storage locations, and the like. The storage locations may also be like storage locations in different locations. For example, the storage locations may include multiple cloud storage locations in different geographical locations, different platform locations, different host locations, or the like. It should be noted that some of the plurality of data sources may be stored or located in the same data storage location. In other words, the location of the data sources does not have to be completely diverse. Rather, the described system and method will work even if all of the data sources are within a single data storage location. Utilizing data sources across different data storage locations is referred to as federated learning.

At 302, the central server computes an influential score of reach of the plurality of data sources. The influential score is computed based upon the data provided to the central server from the data source. The influential score identifies an influence of the data source in accurately predicting annotations of the validation dataset when the data of the data source is used in the training dataset used to train the machine-learning model. Generating the training dataset is an iterative process where data is received from the data sources, aggregated by the central server, and used by the central server to generate a training dataset which is used to train the machine-learning model. The machine-learning model is then tested against the validation dataset to identify an accuracy of the trained machine-learning model. The identified accuracy of the model provides an idea of how good the training dataset is. The aggregated data is then shared with the data sources who use the aggregated data to train a local machine-learning model to generate new data to be provided to the central server. This new data is used to refine the training dataset which is then used to retrain the machine-learning model. The machine-learning model is tested against the validation dataset and this process continues until the process converges. Convergence occurs when the change in the statistics provided to the central server and the aggregated statistics is minimal or under a particular predefined threshold.

A data source that causes the machine-learning model to inaccurately classify datapoints is considered noisy. Noisy data is data that results in an inaccurate prediction or classification of datapoints. In other words, noisy data is data that is incorrect, thereby causing the machine-learning model to learn incorrectly. Noisy data causes the accuracy of the machine-learning model to decrease and is undesirable. Accordingly, the goal is to increase the accuracy of the machine-learning model by removing or ignoring inaccurate data. Thus, the central server attempts to identify the data sources the have the best information so that the central server can use only those data sources to generate the training dataset, thereby making the machine-learning model more accurate or as accurate as possible. The influential score allows the central server to determine which data sources have the best information.

The influence of a data source may be based upon the novelty of the data owned by a data source, a quality of the data owned by a data source, an importance of the data owned by a data source with respect to an objective of the central server, and the like. To compute the influential score, the central server evaluates how useful data of a data source is with respect to the validation dataset. Specifically, the central server evaluates the data of the data source against each datapoint within the validation dataset and determines how useful the data of the data source is in classifying a particular validation datapoint. To compute the influential score, the central server may utilize an influence function that includes a loss function component, a metrics of the data source component, and a gradient of the loss function component. The metrics of the data source component may be a Hessian matrix of metrics of the data of the data source.

In a traditional system where the data is stored in a single location, all components of the influence function can be computed by the central server. As background, the influence function includes a computation of the accuracy of the model trained by the central system against the validation dataset. An example equation for this computation is as follows:

$$\hat{θ} {=}^{def} arg {min}_{θ ∈ Θ {\sum }_{i = 1}^{n}} L ( {z}_{i} , θ )$$

where θ is the parameters of the model you want to learn, n is a number of datapoints in the training dataset, L is the loss where an accurate classification is θ and an inaccurate classification is 1, Zᵢ is a particular datapoint in the validation dataset, and B is the overall loss function.

The influence function also includes a computation of an influence of a particular datapoint within data of a data source on the classification of validation datapoint. This can be computed by dropping a particular point from the data and computing the loss function with dropped point. An example equation for this computation is as follows:

$${\hat{θ}}_{- z} {=}^{def} arg {min}_{θ ∈ Θ {\sum }_{{z}_{i} \neq z}} L ( {z}_{i} , θ )$$

where \hat{θ}_{-Z} is the loss function with dropped point and Z is the dropped point. The influence of the dropped point can then be computed by comparing the overall loss function result with the loss function with dropped point, for example, using \hat{θ}−\hat{θ}_{-Z}. It should be noted that any type of loss function may be utilized and the above are merely examples.

Since these calculations need to be run for every datum in a data source against every datapoint in the validation set, the computation gets cumbersome and time-consuming. Accordingly, a smooth notion of removing Z can be computed and a corresponding closed form expression can be identified as follows:

$${T}_{up , params} ( z ) {=}^{def} \frac{d {\hat{θ}}_{ϵ , z}}{d ϵ} {\vert}_{ϵ = 0} = - {H}_{\hat{θ}}^{- 1} {∇}_{θ} L ( z , \hat{θ} ) , where \\ {H}_{\hat{θ}} {=}^{def} \frac{1}{n} {\sum }_{i = 1}^{n} {∇}_{θ}^{2} L ( {z}_{i} , \hat{θ} )$$

where ∇ is the first derivative of the loss function. However, as noted above, these functions assume that all of the data is stored in a single location which would allow the server to compute all components of the functions. However, in a federated learning environment, the central server is unable to compute some of the components of the influence function.

Accordingly, the influence function can be modified as follows:

$${I}_{up , loss} ( Z , {Z}_{test} ) {=}^{def} - {∇}_{θ} {L ( {Z}_{test} , \hat{θ} )}^{T} {H}_{θ}^{- 1} {∇}_{θ} L ( z , \hat{θ} ) .$$

This influence function can be identified as three components −∇_{θ}L(Zₜₑₛₜ, \hat{θ})^{T} which corresponds to the loss function component, H_{θ}⁻¹ which corresponds to a metrics of the data source component, and ∇_{θ}L (z, θ) which corresponds to a gradient of the loss function component. The loss function component can be computed by the central server using the data shared by the data sources with the central server. The gradient of the loss function component can also be computed by the central server because this information is already shared with the central server. The metrics of the data source component cannot be computed by the central server. However, this component can be computed by each data source locally and the result can be shared with the central server, thereby maintaining the privacy of the data within the data source. The result can then be utilized by the central server along with the loss function component computation and gradient of the loss function component computation to compute an influence of each of the data sources against each of the validation datapoints.

The computation of the influence of each of the data sources against each of the validation datapoints results in an influential score for each of the data sources for each of the validation datapoints. This influential score for each of the validation datapoints can be used to determine if the data source should be included in a subset to be used for generation of the training dataset at 303. The central server, for each validation datapoint, can generate a ranking of the data sources using the influential score of each data source. The ranking ranks the data sources based upon how influential the data source is in accurately predicting the annotation of the datapoint within the validation dataset. Thus, a data source having the highest ranking would be identified as a data source having the most influence in accurately predicting the annotation of a datapoint. The rankings for all of the validation datapoints are aggregated by the central server into a single ranking of the data sources. This single ranking identifies those data sources having the most influence in accurately predicting annotations across the entire validation dataset.

The aggregated ranked list can be used by the central server to select a subset of the plurality of data sources to be used in generating the training dataset which is then used to train the machine-learning model. In other words, the subset is selected by the central server based upon the influential score of each of the plurality of data sources. Selecting the subset may simply include selecting the least number of data sources that cover the validation dataset. Covering the validation dataset means that one or more datum of one or more data sources should cover the datapoint within the validation dataset, meaning that it should allow or facilitate the machine-learning model in accurately predicting the annotation for the datapoint.

Selecting the subset may be based upon one or more constraints that are provided by a user or set within the server. These constraints may be referred to as a coverage budget. One constraint may be a limitation on a maximum number of data sources that can be included in the subset. The subset of data sources that are used should cover the validation dataset. The coverage budget may therefore identify a minimum number of datapoints that need to be covered in the validation dataset by the data of the data sources within the subset. The coverage budget may also identify an upper range for the number of annotated datapoints to be covered, which may assist in reducing a number of data sources included in the subset. Thus, the coverage budget or provided constraints may identify constraints on a number of data sources, a number of the annotated datapoints, and/or the like or a combination thereof.

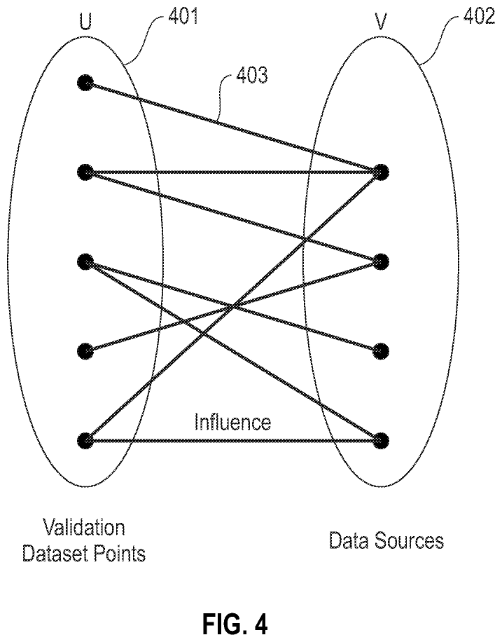

To select the subset, the central server may construct and utilize a bipartite graph. On one side of the bipartite graph may be the validation dataset points and on the other side may be the data sources. The central server may then connect validation dataset points with data sources with an edge. The edge may be a weighted edge which identifies an amount of influence that the data source has on the connected dataset point. A data source that does not have any influence or an influence below a predetermined threshold on a validation datapoint will not have an edge connecting the two. FIG. 4 illustrates a simple example of a bipartite graph. On the left side, the validation dataset points 401 are represented by dots or nodes. On the right side, the data sources 402 are represented by dots or nodes. Data sources having an influence on one or more of the dataset points are connected to the dataset point with weighted edges 403, the weightings being based upon the computed influence discussed in connection with 302. As can be seen in the example of FIG. 4, some data sources may have influence on multiple dataset points and some data sources may have no influence on some dataset points.

The central server attempts to select the minimal number of data sources to be used in the subset. The minimal number of data source are the least number of data sources that can be used to cover the validation dataset. This can be determined using one or more approximation algorithm techniques, for example, an approximate set cover algorithm. Thus, the central server first identifies the most influential data sources, for example, based upon the rankings and/or utilizing the bipartite graph. For example, the system may sum the influence of the edges corresponding to the data source within the bipartite graph. Data sources having a higher influence may be selected for inclusion in the subset. If more than one data source has the same influence, the central server may identify which data source influences the most validation dataset points, for example, as identified through the bipartite graph.

The central server may continue to select data sources for the subset until the coverage budget is reached. In the case that a certain number of validation datapoints need to be covered, the central server may end up selecting a data source that only influences a few datapoints simply because no other data sources cover those datapoints. Thus, the subset may include data sources that are not as influential as other possible data sources simply because certain datapoints need to be covered.

If the central server determines that a data source should not be included in the subset at 303, the central server ignores data received from the data source at 304. In other words, the central server does not integrate the data received from the data source into the training dataset. If the data source is not included in the subset, the central server may also no longer provide updates of the data to the data source. In other words, the central server removes the data source from the iterative process of generating a training dataset. It should be noted that while a data source may be removed from the process of generating one training dataset, the data source may be utilized in a future training dataset for a different machine-learning model. In other words, just because a data source is or is not used for one training dataset does not mean that the data source is automatically excluded or included in generating subsequent training dataset.

If, on the other hand, the central server determines that a data source should be included in the subset at 303, the central server includes the data from that data source into the subset at 305. Additionally, since generation of the training dataset is an iterative process, the central server communicates updated aggregate statistics to the data sources that are included in the subset and receives updated data from that data source based upon the updated aggregate statistics. As explained before, this process continues, using those data sources included in the subset, until the process converges or the change in the statistics is minimal or below a predetermined threshold value.

Once the subset is identified or selected, the central server may generate the training dataset utilizing the data of the data sources included within the subset at 306. As mentioned previously, generation of the training dataset is an iterative process with multiple communications between the central server and the data sources. Once the process converges, the final training dataset is generated. This training dataset can then be used to train the machine-learning model. The training is facilitated by the central server using the training dataset.

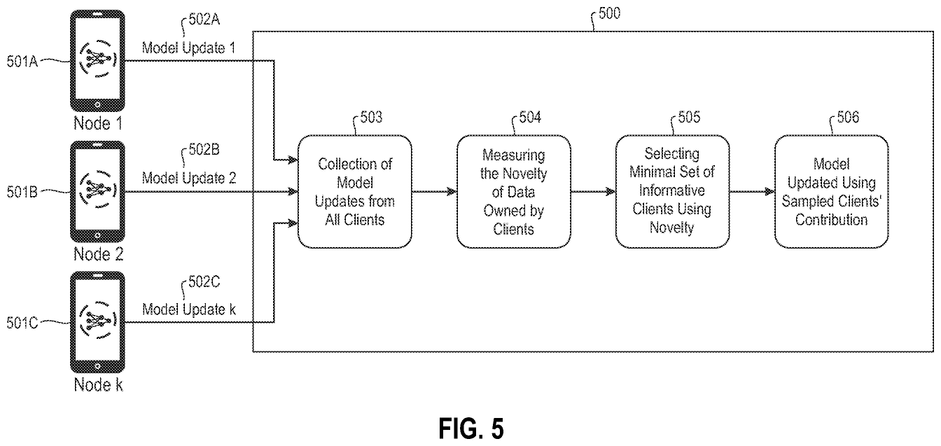

FIG. 5 illustrates an overall system architecture of the described system and method. The central server 500 communicates with a number of data sources or nodes 501A, 501B, and 501C. The data sources 501A-501C provide model updates 502A, 502B, and 502C to the central server 500. The central server collects the model updates from all clients 503. The central server 500 measures the novelty or influence of the data owned by the data sources or clients 504, as described in further detail herein. Based upon the measured novelty or influence, the central server 500 selects a minimal set of informative or influential clients or data sources 505. This minimal set of data sources is then used to update the training dataset which is used to update the model 506.

As shown in FIG. 6, computer system/server 12′ in computing node 10′ is shown in the form of a general-purpose computing device. The components of computer system/server 12′ may include, but are not limited to, at least one processor or processing unit 16′, a system memory 28′, and a bus 18′ that couples various system components including system memory 28′ to processor 16′. Bus 18′ represents at least one of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12′ typically includes a variety of computer system readable media. Such media may be any available media that are accessible by computer system/server 12′, and include both volatile and non-volatile media, removable and non-removable media.

System memory 28′ can include computer system readable media in the form of volatile memory, such as random-access memory (RAM) 30′ and/or cache memory 32′. Computer system/server 12′ may further include other removable/non-removable, volatile/non-volatile computer system storage media. By way of example only, storage system 34′ can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18′ by at least one data media interface. As will be further depicted and described below, memory 28′ may include at least one program product having a set (e.g., at least one) of program modules that are configured to carry out the functions of embodiments of the invention.

Program/utility 40′, having a set (at least one) of program modules 42′, may be stored in memory 28′ (by way of example, and not limitation), as well as an operating system, at least one application program, other program modules, and program data. Each of the operating systems, at least one application program, other program modules, and program data or some combination thereof, may include an implementation of a networking environment. Program modules 42′ generally carry out the functions and/or methodologies of embodiments of the invention as described herein.

Computer system/server 12′ may also communicate with at least one external device 14′ such as a keyboard, a pointing device, a display 24′, etc.; at least one device that enables a user to interact with computer system/server 12′; and/or any devices (e.g., network card, modem, etc.) that enable computer system/server 12′ to communicate with at least one other computing device. Such communication can occur via I/O interfaces 22′. Still yet, computer system/server 12′ can communicate with at least one network such as a local area network (LAN), a general wide area network (WAN), and/or a public network (e.g., the Internet) via network adapter 20′. As depicted, network adapter 20′ communicates with the other components of computer system/server 12′ via bus 18′. It should be understood that although not shown, other hardware and/or software components could be used in conjunction with computer system/server 12′. Examples include, but are not limited to: microcode, device drivers, redundant processing units, external disk drive arrays, RAID systems, tape drives, and data archival storage systems, etc.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure.

Although illustrative embodiments of the invention have been described herein with reference to the accompanying drawings, it is to be understood that the embodiments of the invention are not limited to those precise embodiments, and that various other changes and modifications may be affected therein by one skilled in the art without departing from the scope or spirit of the disclosure.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method, comprising:
receiving, at a central server, data from each of a plurality of data sources, the plurality of data sources being within a plurality of data storage locations, wherein the central server comprises a validation dataset having a plurality of annotated datapoints and wherein the central server trains a machine-learning model utilizing a training dataset;
computing, at the central server, an influential score for each of the plurality of data sources based upon the data provided to the central server from each of the plurality of data sources, wherein an influential score of a data source identifies an influence of the data source in accurately predicting annotations of the validation dataset when the data is used in the machine-learning model;
selecting, at the central server and based upon the influential score of the plurality of data sources, a subset of the plurality of data sources; and
generating, at the central server, the training dataset utilizing the data of the data sources included within the subset.

2. The method of claim 1, wherein the computing comprises evaluating the data of a data source against each annotated datapoint within the validation dataset.

3. The method of claim 2, wherein the computing comprises generating rankings of the plurality of data sources for each annotated datapoint based upon the evaluating.

4. The method of claim 3, wherein the computing comprises aggregating the rankings of the plurality of data sources across the plurality of annotated datapoints of the validation dataset.

5. The method of claim 1, wherein the computing comprises computing an accuracy of the data source in predicting the annotations utilizing an influence function comprising a loss function component, a metrics of the data source component, and a gradient of the loss function component, wherein the loss function component and the gradient of the loss function component is computed at the central server and wherein a result of the metrics of the data source component is provided to the central server from a corresponding data source.

6. The method of claim 1, wherein the selecting comprises constructing a bipartite graph comprising the plurality of annotated datapoints and the plurality of data sources by generating weighted edges between annotated datapoints and data sources based upon the influence of the data source.

7. The method of claim 1, wherein the selecting comprises selecting the subset based upon a coverage budget provided by a user, wherein the coverage budget identifies at least one of a constraint on a number of the plurality of data sources and a constraint on a number of the annotated datapoints.

8. The method of claim 1, wherein the selecting comprises selecting the least number of data sources that covers the validation dataset.

9. The method of claim 1, wherein the data comprises a derivative of data stored locally at the data source to preserve a privacy of the data stored locally at the data source.

10. The method of claim 1, comprising training, at the central server, the machine-learning model utilizing the training dataset.

11. An apparatus, comprising:
at least one processor; and
a computer readable storage medium having computer readable program code embodied therewith and executable by the at least one processor;
wherein the computer readable program code is configured to receive, at a central server, data from each of a plurality of data sources, the plurality of data sources being within a plurality of data storage locations, wherein the central server comprises a validation dataset having a plurality of annotated datapoints and wherein the central server trains a machine-learning model utilizing a training dataset;
wherein the computer readable program code is configured to compute, at the central server, an influential score for each of the plurality of data sources based upon the data provided to the central server from each of the plurality of data sources, wherein an influential score of a data source identifies an influence of the data source in accurately predicting annotations of the validation dataset when the data is used in the machine-learning model;
wherein the computer readable program code is configured to select, at the central server and based upon the influential score of the plurality of data sources, a subset of the plurality of data sources; and
wherein the computer readable program code is configured to generate, at the central server, the training dataset utilizing the data of the data sources included within the subset.

12. A computer program product, comprising:
a computer readable storage medium having computer readable program code embodied therewith, the computer readable program code executable by a processor;
wherein the computer readable program code is configured to receive, at a central server, data from each of a plurality of data sources, the plurality of data sources being within a plurality of data storage locations, wherein the central server comprises a validation dataset having a plurality of annotated datapoints and wherein the central server trains a machine-learning model utilizing a training dataset;
wherein the computer readable program code is configured to compute, at the central server, an influential score for each of the plurality of data sources based upon the data provided to the central server from each of the plurality of data sources, wherein an influential score of a data source identifies an influence of the data source in accurately predicting annotations of the validation dataset when the data is used in the machine-learning model;
wherein the computer readable program code is configured to select, at the central server and based upon the influential score of the plurality of data sources, a subset of the plurality of data sources; and
wherein the computer readable program code is configured to generate, at the central server, the training dataset utilizing the data of the data sources included within the subset.

13. The computer program product of claim 12, wherein the computing comprises evaluating the data of a data source against each annotated datapoint within the validation dataset.

14. The computer program product of claim 13, wherein the computing comprises generating rankings of the plurality of data sources for each annotated datapoint based upon the evaluating.

15. The computer program product of claim 14, wherein the computing comprises aggregating the rankings of the plurality of data sources across the plurality of annotated datapoints of the validation dataset.

16. The computer program product of claim 12, wherein the computing comprises computing an accuracy of the data source in predicting the annotations utilizing an influence function comprising a loss function component, a metrics of the data source component, and a gradient of the loss function component, wherein the loss function component and the gradient of the loss function component is computed at the central server and wherein a result of the metrics of the data source component is provided to the central server from a corresponding data source.

17. The computer program product of claim 12, wherein the selecting comprises constructing a bipartite graph comprising the plurality of annotated datapoints and the plurality of data sources by generating weighted edges between annotated datapoints and data sources based upon the influence of the data source.

18. The computer program product of claim 12, wherein the selecting comprises selecting the subset based upon a coverage budget provided by a user, wherein the coverage budget identifies at least one of a constraint on a number of the plurality of data sources and a constraint on a number of the annotated datapoints.

19. The computer program product of claim 12, wherein the selecting comprises selecting the least number of data sources that covers the validation dataset.

20. The computer program product of claim 12, wherein the data comprises a derivative of data stored locally at the data source to preserve a privacy of the data stored locally at the data source.
